(19) United States
(12) Patent Application Publication
(10) Pub. No.: US 2013/0110885 A1
(43) Pub. Date: May 2, 2013

(54) STORY-BASED DATA STRUCTURES

(71) Applicant: Vox Media, Inc., Washington, DC (US)

(72) Inventor: Gale Noble Brundrett, III, McLean, VA (US)

(73) Assignee: VOX MEDIA, INC., Washington, DC (US)

(21) Appl. No.: 13/665,375

(22) Filed: Oct. 31, 2012

Related U.S. Application Data
(60) Provisional application No. 61/553,939, filed on Oct. 31, 2011.

(51) Int. Cl. G06F 7/00; G06F 17/30

(52) U.S. Cl. 707/812; 707/E17.044

(57) ABSTRACT

Computer-implemented systems, methods, and computer-readable media for storing and presenting content according to a story narrative include hosting a data set including a plurality of entries, wherein each entry is individually addressable in the data set and wherein an entry is a story stream; receiving a new entry; storing the new entry in the data set; receiving from an editor an indication that the new entry is a stream entry associated with the story stream; associating the stream entry with the story stream; and providing an interface for navigation of the story stream and the entries associated with the story stream.

### PRIORITY CLAIM

This application claims priority to the U.S. provisional patent application 61/553,939, filed Oct. 31, 2011, which is hereby incorporated by reference.

### BACKGROUND

Conventionally, information is published as “articles,” (i.e., standalone items that describe a situation or event). For example, articles appear in newspapers and on web sites. If an article is part of an evolving story, updates to the article can be published or various new articles relating to the evolving story can be aggregated over time.

For example, blogs tend to consist of articles (also referred to as “posts”), updates to articles, and comments arranged in a chronological manner. However, a blog is only indexable as a single entity and blog posts are only arranged chronologically. In some instances, blog posts may be associated with a searchable keyword. While these features make blogs an efficient platform for quickly distributing information, they do not provide an efficient way for a user to follow an evolving story. In other words, for a user to follow an evolving story, the user must either read all new blog posts as they are published to see if they relate to the story of interest, or the user may search a keyword related to the story and read all related content. Either way, blogs often flood readers with content related to a topic that may be completely unrelated to a story of interest.

Other web sites aggregate content related to a topic, for example by tagging articles by topic, crawling articles and recognizing text, and the like. For example, Google News aggregates news articles by carrying out contextual analysis and grouping articles relating to a similar topic together. However, aggregated content about a topic does not follow a story.

Other platforms, such Storify, allow users to arrange social media content to follow a narrative. For example, a user may arrange tweets, blog posts, articles, and the like from social media networks to form a “story.” However, this simply creates an aggregation of content from social media into a single unified object.

Improved methods and systems for creating, organizing, navigating, and displaying content related to a story are desirable.

### BRIEF DESCRIPTION OF THE DRAWINGS

FIG. 1 illustrates an exemplary data set in one or more data stores useful for arranging entries within story streams.

FIG. 2 illustrates an exemplary structure of an entry that an editor has identified as part of the narrative of plural story streams.

FIG. 3 provides a detailed illustration of an exemplary story stream entity data structure.

FIG. 4 illustrates an exemplary web interface for a user to view a story stream.

FIG. 5 illustrates an exemplary architecture useful for storing and hosting story-centric content.

FIG. 6 shows an exemplary computing device useful for performing processes disclosed herein.

While systems and methods are described herein by way of examples and embodiments, those skilled in the art recognize that systems and methods for organizing and presenting stories in story stream ontologies and data structures are not limited to the embodiments or drawings described. It should be understood that the drawings and description are not intended to be limited to the particular form disclosed. Rather, the intention is to cover all modifications, equivalents and alternatives falling within the spirit and scope of the disclosed embodiments. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include,” “including,” and “includes” mean including, but not limited to.

### DETAILED DESCRIPTION

In order to present evolving stories in a manner that can be easily followed by a user, embodiments are configured to allow editors to structure stories into story streams. A content provider may publish various entries (e.g., articles) on various topics. When an editor identifies an evolving story, he or she can identify an entry as the seed of a story stream. An editor may then identify additional entries that follow the storyline and they can be added as story entries in the story stream. Content creators may also create new entries which may be directly added to evolving story streams.

Embodiments provide data structures, ontologies, user interfaces, and related technologies that allow for individual entries to be stand-alone entries, elements within one or more story streams, and the seed of one or more story streams. Embodiments also provide systems and tools to allow editors to add existing entries to story streams. Further, embodiments may allow authors of content to create entries for specific story streams.

Data structures and ontologies disclosed herein are advantageously story-centric as opposed to conventional topic-centric arrangements. Entries may be arranged within the data structures and ontologies by human editors so that entries within a story stream advance a story line. The data structures may be recursive, allowing for entries to be part of multiple story streams and multiple entries may be part of a single story stream. Each entry may be individually addressable, for example having its own universal resource locator (URL), thereby allowing each entry to be navigated to independent of whether the entry is an entry within one or more story streams or the seed of one or more story streams. The following describes exemplary embodiments in greater detail.

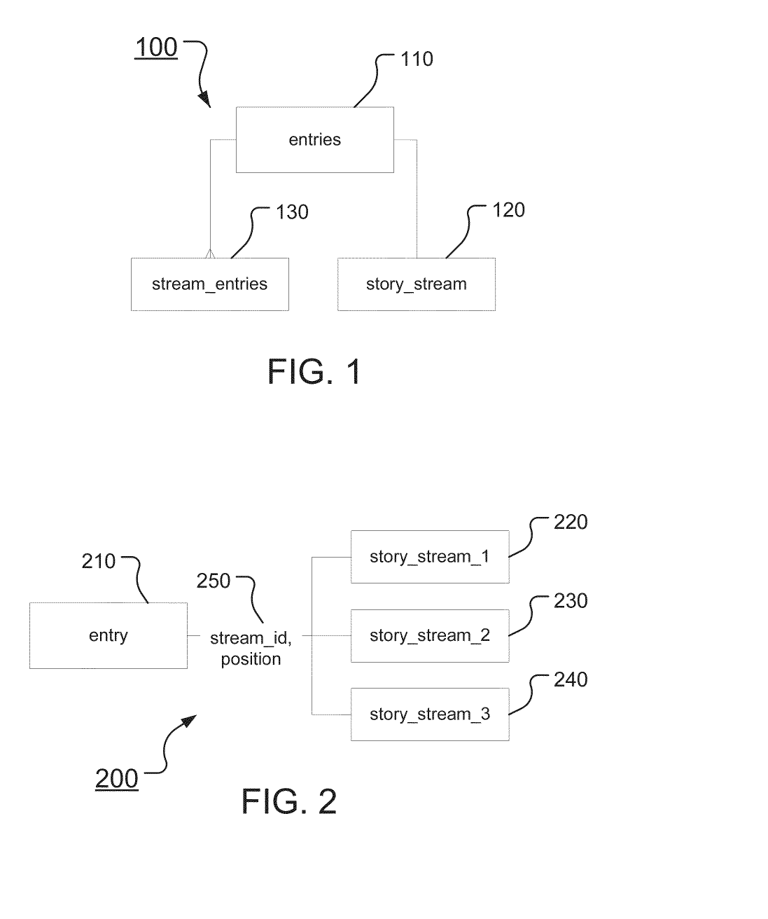

FIG. 1 illustrates an exemplary data set 100 in one or more data stores useful for arranging entries within story streams. Entries 110 may be any digital content. For ease of explanation, embodiments described herein will generally refer to entries 110 as if they are all articles. However, entries may be any type of digital content that may be stored in a data store, such as images, videos, audio, and the like. Each entry 110 includes both the content of the entry (e.g., the article itself) as well as metadata (e.g., the title of the article, a unique identifier (ID) for the article, an author ID, a summary, etc.). An entry 110 may be a single data type (e.g., text only), mixed data types (e.g., text with a picture, text with embedded media, etc.), a link to an external entry (e.g., a URL of an entry hosted remotely), embedded media, and the like. Each entry 110 may be individually addressable, for example via a URL and hosted via a web server, thereby allowing a user to navigate directly to each entry 110 and for each entry to be displayed directly within a story stream.

One or more entries 110 in the data set 100 may also be the root of a story_stream 120. One or more human editors may review entries 110 and, when a discrete entry begins to evolve into a developing story, the human editor may identify the entry as a story_stream 120. Each story_stream 120 thus may be an entry 110 and may also have additional metadata (e.g., a story_stream ID, a summary of the stream, a link to the full story_stream (discussed in greater detail below), etc.). In some embodiments an entry 110 may only be a single story_stream 120 entry, however embodiments may also allow an entry 110 to be multiple, separately addressed story_streams 120.

Entries 110 in the data set 100 may also be stream_entries 130 within one or more story_streams 120. One or more human editor may review entries 110 and determine when an entry 110 furthers the narrative of a story stream. If so, the editor may identify the entry 110 as a stream_entry 130 within a story_stream 120. Each stream_entry 130 may include various metadata (e.g., an entry ID, the stream ID of the stream it is an entry within, the position of the entry within the stream, a link to the entry within the story stream, etc.). A single entry 110 may be a stream_entry 130 within several separate story_streams 120 if so identified by an editor.

A content creator (e.g., a journalist) may also author or otherwise create a new entry 110 to be directly entered as a stream_entry 130 within a story_stream 120. For example, a content creator may write an article intended to be the next chapter in the evolving narrative of the story stream. However, because the article is individually addressable, an editor may also add the article as a stream entry to one or more other story streams. Further, while the article may be an element of an existing story stream, if an editor identifies the article as a root of a separate evolving story, the editor may also create a new story stream rooted at the article.

Thus, embodiments provide a recursive data structure that allows entries 110 in a data set 100 to be arranged by human editors into story_streams 120 having story stream_entries 130 arranged according to the evolving story. Thus, embodiments allow a structure for human editors to efficiently curate evolving narratives by recursively arranging content in a story-centric fashion. Story streams may be hosted to allow users to navigate a story as it evolves, with each consecutive stream_entry 130 within a story_stream 120 furthering the narrative of the story.

Embodiments provide great advances over topic-centric content aggregation. In conventional topic-centric organization of content, users are often overwhelmed with content loosely related to a topic but not furthering the specific story the user is interested in. Further, such users are often inundated by cumulative articles that provide the same information from different sources. Articles organized by keywords, topic tags, contextual analysis, and the like fail to provide entries arranged to further a single storyline. Embodiments overcome these limitations by arranging entries in data structures that allow editors to easily identify entries that are the root of evolving stories to create story streams and identify entries that further the narrative of existing story streams to create story stream entries.

FIG. 2 illustrates an exemplary structure 200 of an entry 210 that an editor has identified as part of the narrative of plural story streams 220, 230, and 240. The entry 210 may include metadata 250 that provides the stream_id of each story stream it is a member of as well as its position (e.g., chapter) in each stream. For example, an editor may identify an entry 210 which is an article about an athlete's suspension as furthering an ongoing story_stream_1 220 about a team's waning season, a story_stream_2 230 about the player's off-the-field difficulties, and a story_stream_3 230 about the league's increased use of suspensions to curb off-the-field behavior. By having an editor curate the narratives of the story streams, stories may evolve in a meaningful, story-centric way. A user navigating the streams may view entries arranged to reflect the evolution of the story. Topic-centric aggregations fail to provide such data structures and fail to facilitate users interfacing with content in such a fashion.

The ontology illustrated in FIG. 2 also illustrates that recommendations can be easily gleaned from an entry 210 a user navigates to. For example, a user following story_stream_2 230 that navigates to entry 210 may also be interested in story_stream_1 220 and story_stream_3 240. Thus, embodiments may provide a web page showing entry 210 within story_stream_2 230 and may also provide links with relevant narrative information (e.g., title and brief summary) of other story streams the entry 210 is part of. In another embodiment, a user may navigate directly to entry 210 as a stand-alone article and may be presented with links to each of the story streams 220-240.

Embodiments also allow for meaningful dissemination of new content much more quickly than conventional media platforms. For example, a new entry entered in the data set may be a real-time social media post (e.g., a Twitter “tweet” or other real-time micro-blog post) from an athlete. Conventional social media platforms may provide the content of the post, however any user not attentively following an evolving story may not understand the context of the content by itself. Conventional news platforms would write an article to provide the background context to the post, the post itself, and provide commentary. Embodiments may meaningfully disseminate the post both more quickly and in easier context for a user to understand by publishing the post as a stream entry within a story stream. The various entries already in the story stream could provide context to the user. The post could then be more quickly disseminated by not requiring an author to set the stage for the post. Rather, the post would simply be the next chapter of the story. Additionally, an author may write a new article providing commentary or further details after the post is published with the new article being added as a later stream entry in the story stream.

Any type of content can be mixed into story streams. For example, a story stream including several article entries may also include a photo entry and a video entry. Because the entries within a story stream are contextually arranged, an editor may add various types of entries within a story stream and the surrounding entries may provide context for the new photo or video entry.

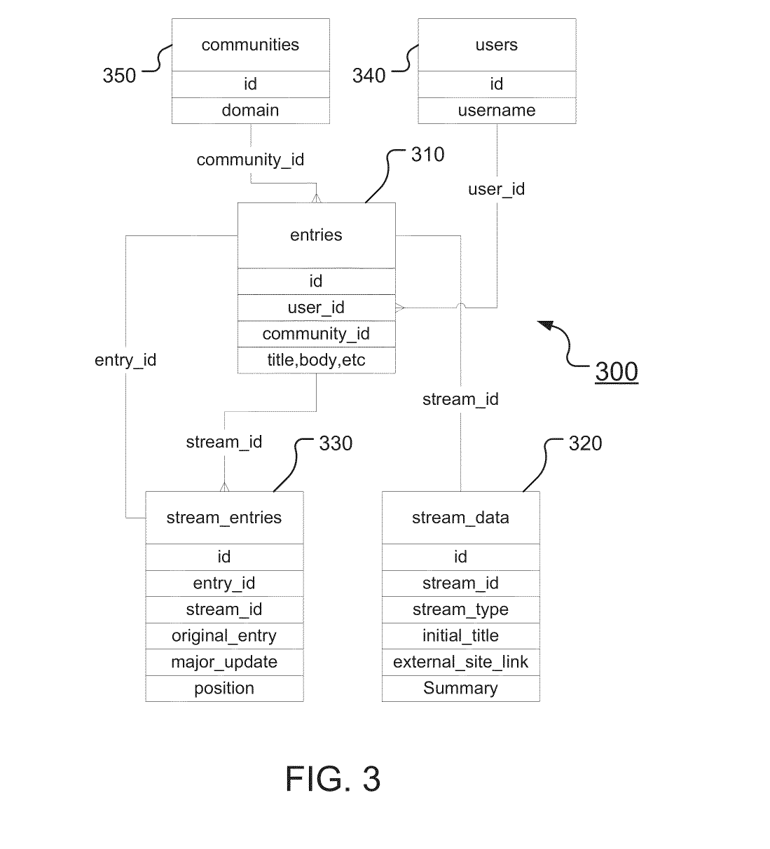

FIG. 3 provides a detailed illustration of an exemplary story stream entity data structure 300. An entry table 310 may include plural entries each including an ID (e.g., a unique identifier), a user_ID (e.g., a unique identifier of the user who created the entry (i.e., the author in the case of an article)), a community_ID (e.g., a unique identifier of the community the entry was created for), a title, a body (e.g., the text of an article, a picture, etc.), a URL (not shown), and the like. Each entry may be a standalone entry, much like a conventional article. Each entry may also be a stream object in a stream_data table 320 to seed a story stream. Each stream object may include an ID, a stream_ID, a stream_type (e.g., in some cases a stream may be limited to a single data type, such as images, articles, etc.), an initial_title (i.e., a title for the story stream), an external_site_link (i.e., a URL for the story stream), and a summary of the story stream. Each entry may also be a stream entry object in a stream_entries table 330 within one or more story streams. Each stream entry object may include an ID, an entry_id, a stream_id (e.g., indicating the stream the stream_entry is a part of), an original_entry, a major_update (e.g., to differentiate content added to an updated entry from the original content), and a position (e.g., a chapter within an evolving story stream).

A users table 340 may include a user associated with each entry (e.g., an author of an article, a photographer of a photo, a commenter or tipster who provides content, etc.). Each user in the table may have an ID, a username (e.g., for logging into a page hosting a story stream), additional login credentials (e.g., a password), an email address, and the like. A single user may be associated with a plurality of entries in entries table 310.

A communities table 350 may include a community associated with one or more entry. For example, a sports website may include plural communities each directed toward a specific sport, a specific team, and the like. This may enable discrete communities on-line to create and store content in a unified data structure but for such communities to only see and have access to their discrete data. This feature of entries may allow for an editor of a specific sport community to effectively develop story streams within their sport, but for a separate editor of a general sport page who has access to entries across communities to effectively develop story streams spanning multiple sports. Each community in the communities table 350 may include an ID, a domain, and the like.

Of course, data structure 350 is only an illustrative example. Alternative embodiments may be structured differently and may include more or less tables or objects within tables. For example, embodiments may include a table of users who like an entry or a stream, for example those who use social-media controls to indicate their like (e.g., FaceBook “like,” Twitter “tweet,” Google “+1,” etc.). Such data may be useful for notifying such users of other entries or story streams that may be of interest. By way of further example, embodiments may include a followers table associated with story streams indicating users who subscribe to a story stream. A followers table may include contact information (e.g., email address, cell phone number, Facebook or other account information, internet protocol (IP) address, etc.) for a user useful for notifying the user when new stream entries are entered into a story stream the user is following. For example, embodiments may send the user an email, send the user a text message (i.e., a short message service (SMS) message), post in the user's Facebook news feed, and the like when a new entry is entered into a story stream the user is following. In alternative embodiments a user may have a software application (e.g., a conventional application on a personal computer or an app on a tablet or smartphone) and new entries in streams the user is following may be pushed to the user's device.

Embodiments may be configured to allow human editors to indicate when an entry in the entry table 310 should become a seed of a new story stream because it is the root of an evolving story or should be entered as an entry within a story stream because it furthers the story stream's narrative. By providing a recursive data structure, such as the exemplary data structure shown in FIG. 3, editors may efficiently curate content to allow for story-centric display or distribution of content to users.

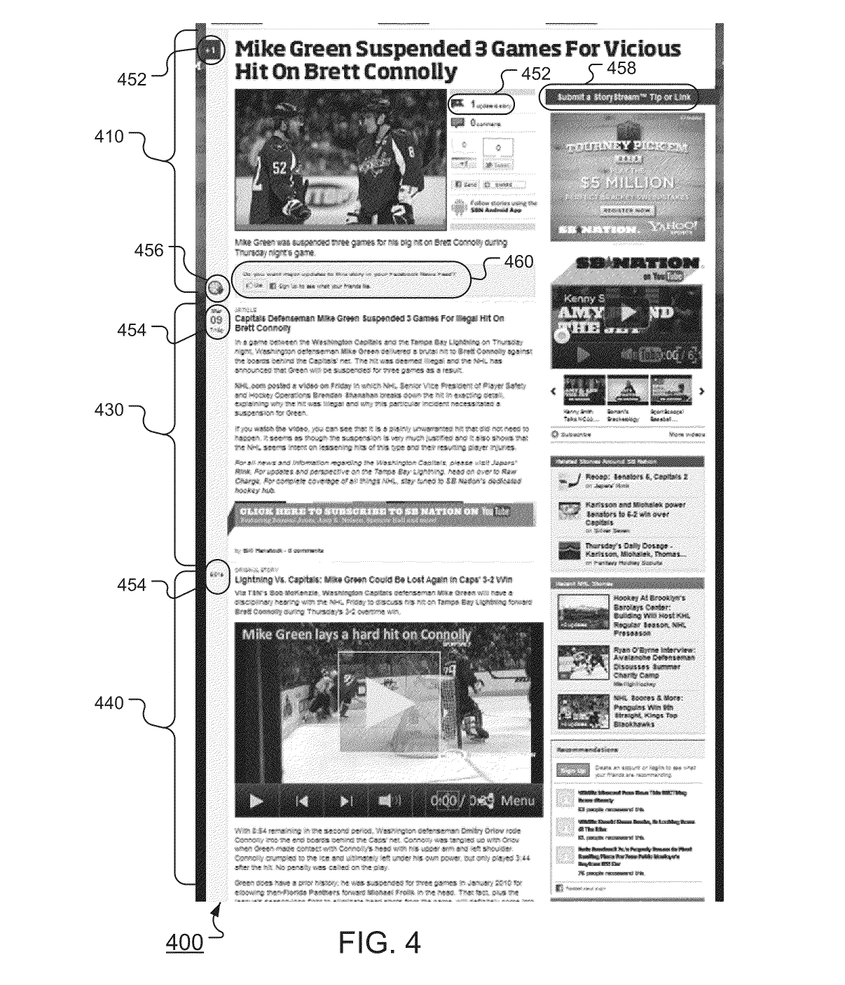

The data structures and ontologies disclosed herein support many new ways for users to follow evolving stories. For example, FIG. 4 illustrates an exemplary web interface 400 for a user to view a story stream. The exemplary story stream interface includes a summary 410 including a title, an image, and a brief caption. Web interface 400 also includes plural stream entries 430 and 440 within the story stream. Embodiments may arrange entries within a stream according to the narrative of the story, for example in the exemplary embodiment stream entry 440 describes a hit in a hockey game then stream entry 430 provides an update explaining that the player who gave the hit received a suspension. In addition to the content included in each entry, entries may display the date and/or time 454 they were added to the story stream. User interface controls 456 may be provided to allow a user to rearrange a story stream to view older entries before newer entries (e.g., to allow a user not familiar with a story to get up to speed). While this embodiment displays entries listed in order on a single web page, alternative embodiments may display entries as a slide show or in any other fashion.

Other user interface controls may also be provided. For example, one or more update indicators 452 may provide a count of the number of updates (i.e., entries) in a story stream. Social media controls, such as a Facebook “like” button 460, may be provided to allow a user to integrate the story stream with their social media experience. Additionally, a tip or link control 458 may be provided to allow a user to provide tips or links relating to the story. Such tips or links may be submitted to a human (e.g., an editor, journalist, etc.) to allow them to determine whether additional entries should be added to the story stream, whether a new entry should be created to further the narrative of the story stream, whether a new story stream should be seeded from an entity in the existing story stream, and the like. Of course, these user interface controls illustrate examples only, and additional or different user interface controls may be useful in alternative embodiments.

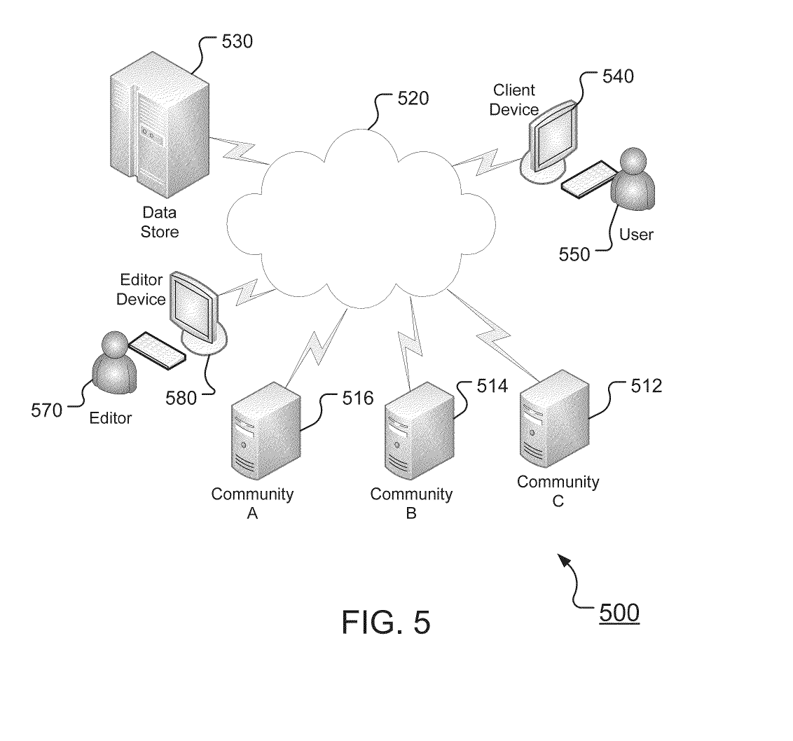

FIG. 5 illustrates an exemplary architecture 500 useful for storing and hosting story-centric content. Architecture 500 includes one or more data store 530 configured to store entries in a story-centric fashion. Data store 530 may be a physical, non-transitory storage medium which may be located in a single storage device or multiple storage media distributed across devices connected by one or more networks. Data store 530 may be configured to be network accessible, thereby allowing one or more computing device connected to a network 520 (e.g., the internet) to access story-centric data. Data store 530 may be configured to provide access to an editor device 580 to allow an editor 570 to arrange entries stored in data store 530 into story streams.

Data store 530 may also be accessible by one or more web servers 516, 514, and 512 configured to host web sites to various communities. Web server 516 may host a site including entries associated with a community A, web server 514 may host a site including entries associated with a community B, and web server 512 may host a site including entries associated with a community C. Editors and authors of content for each community may see entries, including story stream entries and story stream elements, on data store 530 associated with their community. Thus, although multiple communities may store their entries on a single data store 530, the data may be structured to appear to be on separate, discrete data stores.

In other embodiments, editors and authors of content for a community may have access to entries outside of their community. This may enable an editor for community A to insert an entry from community B into a story stream on community A's web server 516. In this fashion, a vast amount of content may be easily accessible to organize story-centric data structures.

Embodiments may provide various tools for editors to organize entries into story streams. For example, an editor may be provided with graphical user interface tools configured to allow the editor to easily create story streams from entries, add entries to or remove entries from existing story streams, arrange the position of entries within a story stream, and the like. Additionally, different editors may have different rights to access and organize data within data store 530. Of course, the term “editor” is used generally herein to refer to any user who may access and control the organization of entries in data store 530. The term “editor” is not limited to a formal position for a person within a publication entity.

Embodiments allow a user 550 using a client device 540 to access entries organized into story streams from data store 530. For example, client device 540 may access a web page displaying story streams from a web server such as web server 516. Alternatively, client device 540 may access story streams from a third party, such as Facebook. In other embodiments, a client device 540 may have software installed thereon that can pull story streams and updates to story streams from data store 530 or software that can receive story streams and updates from story streams pushed from data store 530. Client device 540 may be a conventional computing device (e.g., a personal computer or Apple computer), a smartphone (e.g., an Apple iPhone, an Android phone, etc.), a tablet (e.g., an Apple iPad, an Android tablet, etc.), a set top box, an internet connected television, or any other device capable of displaying entries in story streams.

In one exemplary embodiment, a client may be an Android smartphone having an app installed that allows a user to navigate story streams and entries hosted on data store 530 (i.e., the client device 540 can “pull” data from data store 530) and also allows a user to “follow” story streams so that every time an entry is added to a story stream the entry is “pushed” from data store 530 to the client device 540.

Data store 530 may be configured to have one or more Application Programming Interfaces (APIs) to allow one or more other computing systems to communicate with data store 530. For example, APIs may allow other web sites to syndicate content to other media delivery outlets. Data store 530 may also be configured to distribute content, including entries, story streams, story stream updates, and the like, in alternative fashions, such as via Really Simple Syndication (RSS) feeds, SMS messages, and the like.

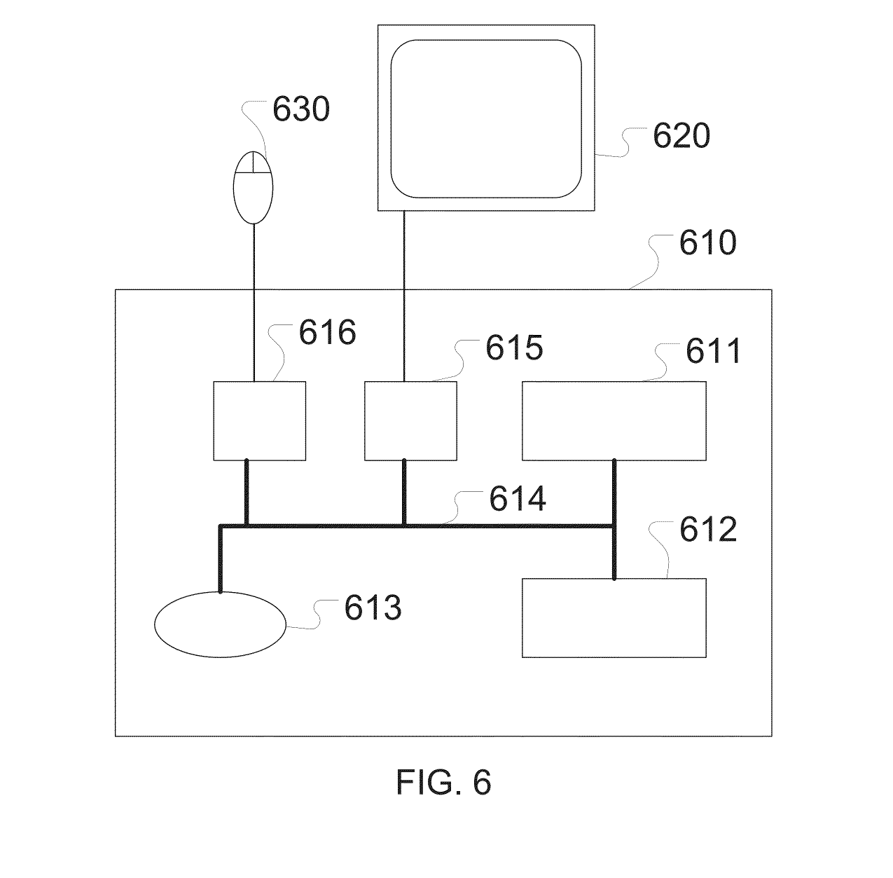

Embodiments described herein may be implemented with software, for example modules executed on computing devices such as computing device 610 of FIG. 6. Of course, modules described herein illustrate various functionalities and do not limit the structure of any embodiments. Rather the functionality of various modules may be divided differently and performed by more or fewer modules according to various design considerations.

Computing device 610 has one or more processing device 611 designed to process instructions, for example computer-readable instructions (i.e., code) stored on a storage device 613. By processing instructions, processing device 611 may perform the steps and functions disclosed herein. Storage device 613 may be any type of storage device (e.g., an optical storage device, a magnetic storage device, a solid state storage device, etc.), for example a non-transitory storage device. Alternatively, instructions may be stored in one or more remote storage devices, for example storage devices accessed over a network or the internet. Computing device 610 additionally may have memory 612, an input controller 616, and an output controller 615. A bus 614 may operatively couple components of computing device 610, including processor 611, memory 612, storage device 613, input controller 616, output controller 615, and any other devices (e.g., network controllers, sound controllers, etc.). Output controller 615 may be operatively coupled (e.g., via a wired or wireless connection) to a display device 620 (e.g., a monitor, television, mobile device screen, touch-display, etc.) in such a fashion that output controller 615 can transform the display on display device 620 (e.g., in response to modules executed). Input controller 616 may be operatively coupled (e.g., via a wired or wireless connection) to input device 630 (e.g., mouse, keyboard, touch-pad, scroll-ball, touch-display, etc.) in such a fashion that input can be received from a user.

Of course, FIG. 6 illustrates computing device 610, display device 620, and input device 630 as separate devices for ease of identification only. Computing device 610, display device 620, and input device 630 may be separate devices (e.g., a personal computer connected by wires to a monitor and mouse), may be integrated in a single device (e.g., a mobile device with a touch-display, such as a smartphone or a tablet, a web-enabled TV, or any other web-enabled device), or any combination of devices (e.g., a computing device operatively coupled to a touch-screen display device, a plurality of computing devices attached to a single display device and input device, etc.). Computing device 610 may be one or more servers, for example a farm of networked servers, a clustered server environment, or a cloud network of computing devices.

Embodiments provide many additional benefits. For example, by providing individually addressable entries, search engines (e.g., Google, Bing, etc.) may independently index each entry according to the search engine's indexing algorithm. At the same time, because an entry may be part of one or more story streams, the search engines may also index each story stream. This may allow a user to both locate an article about a specific topic, and view additional story-centric content.

Embodiments have been disclosed herein. However, various modifications can be made without departing from the scope of the embodiments as defined by the appended claims and legal equivalents.

What is claimed is:

1. A computer-implemented method executed by one or more computing devices for storing and presenting content according to a story narrative, the method comprising:
hosting, by at least one of the one or more computing devices, a data set including a plurality of entries, wherein each entry is individually addressable in the data set and wherein an entry is a story stream;
receiving, by at least one of the one or more computing devices, a new entry;
storing, by at least one of the one or more computing devices, the new entry in the data set;
receiving, by at least one of the one or more computing devices, from an editor an indication that the new entry is a stream entry associated with the story stream;
associating, by at least one of the one or more computing devices, the stream entry with the story stream; and
providing, by at least one of the one or more computing devices, an interface for navigation of the story stream and the entries associated with the story stream.

2. The method of claim 1, wherein the editor is a human who can determine the narrative relation between the new entry and the story stream.

3. The method of claim 2, wherein the editor specifies a position for the new entry in the story stream such that the new entry furthers the narrative of the story stream.

4. The method of claim 1, wherein each entry in the data set includes a unique universal resource locator and wherein the interface allows a user to navigate to the universal resource locator of each entry associated with the story stream.

5. The method of claim 1, further comprising:
receiving, by at least one of the one or more computing devices, a user request to follow the story stream; and
notifying, by at least one of the one or more computing devices, the user when one or more additional entries are added to the story stream.

6. The method of claim 5, wherein the step of notifying the user includes pushing one or more additional entries to a user computing device when the one or more additional entries are added to the story stream.

7. The method of claim 1, further comprising:
receiving, by at least one of the one or more computing devices, from the editor a request to create a new story stream from one of the plurality of entries;
generating, by at least one of the one or more computing devices, the new story stream;
receiving, by at least one of the one or more computing devices, from the editor a request to associate another entry from the plurality of entries with the new story stream; and
associating, by at least one of the one or more computing devices, the another entry with the new story stream.

8. A system for storing and presenting content according to a story narrative comprising:
a memory; and
a processor operatively coupled to the memory, the processor configured to perform the method of:
hosting a data set including a plurality of entries, wherein each entry is individually addressable in the data set and wherein an entry is a story stream;
receiving a new entry;
storing the new entry in the data set;
receiving from an editor an indication that the new entry is a stream entry associated with the story stream;
associating the stream entry with the story stream; and
providing an interface for navigation of the story stream and the entries associated with the story stream.

9. The system of claim 8, wherein the editor is a human who can determine the narrative relation between the new entry and the story stream.

10. The system of claim 9, wherein the editor specifies a position for the new entry in the story stream such that the new entry furthers the narrative of the story stream.

11. The system of claim 8, wherein each entry in the data set includes a unique universal resource locator and wherein the interface allows a user to navigate to the universal resource locator of each entry associated with the story stream.

12. The system of claim 8, wherein the process is further configured to perform the steps:
receiving a user request to follow the story stream; and
notifying the user when one or more additional entries are added to the story stream.

13. The system of claim 12, wherein the step of notifying the user includes pushing one or more additional entries to a user computing device when the one or more additional entries are added to the story stream.

14. The system of claim 8, wherein the processor is further configured to perform the steps:
receiving from the editor a request to create a new story stream from one of the plurality of entries;
generating the new story stream;
receiving from the editor a request to associate another entry from the plurality of entries with the new story stream; and
associating the another entry with the new story stream.

15. A non-transitory computer-readable medium having computer-readable code stored thereon that, when executed by a computing device, performs a method for storing and presenting content according to a story narrative, the method comprising:
hosting a data set including a plurality of entries, wherein each entry is individually addressable in the data set and wherein an entry is a story stream;
receiving a new entry;
storing the new entry in the data set;
receiving from an editor an indication that the new entry is a stream entry associated with the story stream;
associating the stream entry with the story stream; and
providing an interface for navigation of the story stream and the entries associated with the story stream.

16. The medium of claim 15, wherein the editor is a human who can determine the narrative relation between the new entry and the story stream.

17. The medium of claim 16, wherein the editor specifies a position for the new entry in the story stream such that the new entry furthers the narrative of the story stream.

18. The medium of claim 15, wherein each entry in the data set includes a unique universal resource locator and wherein the interface allows a user to navigate to the universal resource locator of each entry associated with the story stream.

19. The medium of claim 15, wherein the method further comprises:
receiving a user request to follow the story stream; and
notifying the user when one or more additional entries are added to the story stream,
wherein the step of notifying the user includes pushing one or more additional entries to a user computing device when the one or more additional entries are added to the story stream.

20. The medium of claim 15, wherein the method further comprises:
receiving from the editor a request to create a new story stream from one of the plurality of entries;
generating the new story stream;
receiving from the editor a request to associate another entry from the plurality of entries with the new story stream; and
associating the another entry with the new story stream.
